(19) United States
(12) Patent Application Publication
(10) Pub. No.: US 2007/0142650 A1
(43) Pub. Date: Jun. 21, 2007

(54) Method of making epoxyorganoalkoxysilanes

(76) Inventor: Byron Duane Eilenstine, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/591,334

(22) PCT Filed: Jan. 13, 2005
(86) PCT No.: PCT/US05/00907

§ 371 Date: Aug. 31, 2006

Related U.S. Application Data
(60) Provisional application No. 60/557,206, filed on Mar. 29, 2004.

(51) Int. Cl. C07F 7/02

(52) U.S. Cl. 549/215

(57) ABSTRACT

Epoxyorganoalkoxysilanes are made by reacting an olefin epoxide with an hydridoalkoxysilane in the presence of RhCl(di-tert-butylsulfide)₂ catalyst. The reaction is free of the presence of a stabilizing agent, it is carried out at a temperature in the range of 65-95° C., and the olefin epoxide is present in the reaction in a molar excess of 5-25 percent over the stoichiometric amount necessary to react with the hydridoalkoxysilane. Preferably, the reaction temperature is in the range of 70-75° C., and the olefin epoxide is present in the reaction in a molar excess of about 10 percent over the stoichiometric amount necessary to react with the hydridoalkoxysilane.

### DESCRIPTION

This invention is related to the preparation of epoxyorganoalkoxysilanes by the hydrosilation reaction of an olefin epoxide and a hydridoalkoxysilane in the presence of a rhodium catalyst.

Hydrosilation is a known reaction involving the addition of a silicon hydride to an unsaturated hydrocarbon to form a silicon-carbon bond. It has been described in a number of US Patents including U.S. Pat. No. 5,208,358 (May 4, 1993), U.S. Pat. No. 5,258.480 (Nov. 2, 1993), and U.S. Pat. No. 6,365,696 (Apr. 2, 2002), for example. The present invention is an improvement on hydrosilation reactions as described in these patents.

Thus, while the '358 patent shows the particular rhodium catalyst used herein, the catalyst is used to make silyl ketene acetals by hydrosilation rather than to make epoxyorganoalkoxysilanes. The process of the '480 patent, while it teaches reacting olefin epoxides and hydridoalkoxysilanes to make epoxyorganoalkoxysilanes, the '480 patent uses a different rhodium catalyst, and it requires the presence of a tertiary amine stabilizer such as methyldicocoamine to prevent gellation caused by epoxide ring opening during the hydrosilation reaction. Similarly, the '696 patent, while it teaches reacting olefin epoxides with hydridoalkoxysilanes to make epoxyorganoalkoxysilanes, the '696 patent uses a different rhodium catalyst, and it requires the presence of a carboxylic acid salt such as ammonium acetate to eliminate epoxide ring opening polymerization.

The invention is directed to an improved method of making epoxyorganoalkoxysilanes by hydrosilation, in which an olefin epoxide is reacted with an hydridoalkoxysilane, in the presence of a rhodium catalyst. In particular, the rhodium catalyst is RhCl(di-tert-butylsulfide)₂, i.e., RhCl[(CH₃)₃C)₂S]₂. It has been unexpectedly discovered that this particular rhodium catalyst is capable of catalyzing such hydrosilation reactions without opening of the epoxy ring, and that it can be used to catalyze such reactions without the aid or addition of stabilizers such as tertiary amines and carboxylic acid salts.

More particularly, the invention is directed to a method of making epoxyorganoalkoxysilanes by reacting an olefin epoxide with an hydridoalkoxysilane in the presence of RhCl(di-tert-butylsulfide)₂ catalyst, in which (i) the reaction is free of the presence of a stabilizing agent, (ii) the reaction is carried out at a temperature in the range of 65-95° C., and (iii) the olefin epoxide is present in the reaction in a molar excess of 5-25 percent over the stoichiometric amount necessary to react with the hydridoalkoxysilane.

Preferably, the reaction temperature is in the range of 70-75° C., and the olefin epoxide is present in the reaction in a molar excess of about 10 percent over the stoichiometric amount necessary to react with the hydridoalkoxysilane.

These and other features of the invention will become apparent from a consideration of the detailed description.

Hydridoalkoxysilanes that can be used in the hydrosilation reaction method according to the invention include organosilicon compositions such as trimethoxysilane HSi(OCH₃)₃, triethoxysilane HSi(OC₂H₅)₃, tri-n-propoxysilane HSi(OC₃H₇)₃, tri-isopropox HSi[(OCH(CH₃)₂]₃, methyldimethoxysilane (CH₃)HSi(OCH₃)₂, methyldiethoxysilane (CH₃)HSi(OC₂H₅)₂, dimethylmethoxysilane (CH₃)₂HSi(OCH₃), dimethylethoxysilane (CH₃)₂HSi(OC₂H₅), and phenyldiethoxysilane (C₆H₅)HSi(OC₂H₅)₂

Olefin epoxides suitable for use in the hyrdosilation reaction method according to the invention can be compositions such as described in the '480 patent, including limonene oxide, allyl glycidyl ether, glycidyl acrylate, 1,2-epoxy-5-hexene, 1,2-epoxy-7-octene, 1,2-epoxy-9-decene, vinyl norborene monoxide, and dicyclopentadiene monoxide. Other olefin epoxides which can be used include those ethylenically unsaturated epoxides described in the '696 patent, such as butadiene monoxide (3,4-epoxy-1-butene), 4-vinylcyclohexene monoxide (VCMX), and 1-methyl-4-isopropenyl cyclohexene monoxide.

As noted above, the catalyst used in carrying out the hydrosilation reaction according to the invention is the rhodium catalyst RhCl(di-tert-butylsulfide)₂, i.e., RhCl[(CH₃)₃C)₂S]₂. It can be prepared by standard procedures used for reacting RhCl₃ and di-tert-butylsulfide.

In a most preferred embodiment of the present invention, the hydridoalkoxysilane used is trimethoxysilane, and it is reacted with an olefin oxide which is vinylcyclohexene monoxide, in the presence of rhodium catalyst RhCl(di-tert-butylsulfide)₂, to produce the epoxyorganoalkoxysilane composition 2-(3,4-epoxycyclohexyl)ethyltrimethoxysilane. This reaction scenario is shown below:

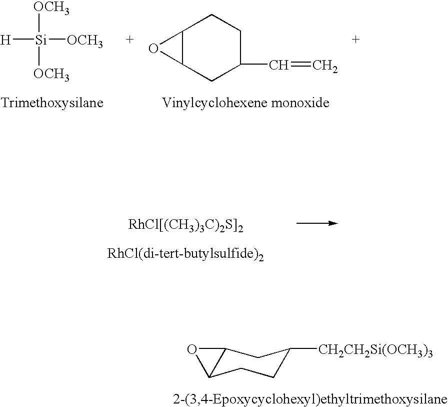

The method according to the invention is carried out using from 10-30 parts per millon of the rhodium catalyst, based on the combined weight of all of the ingredients used in the reaction. The preferred amount of the catalyst is about 15 parts per million. The hydridoalkoxysilane and the olefin epoxide are used in amounts such as to provide a 5-25 percent molar excess of the olefin epoxide over the stoichiometric amount. The preferred amount of olefin epoxide is such as to provide about a 10 percent molar excess of olefin epoxide. The reaction can be carried out at a temperature range of 65-95° C., preferably at a range of 70-75° C., and at atmospheric pressure. If desired, solvents may be used in the reaction such as hydrocarbon compositions, including toluene, octane and xylene for example. The reaction can be carried out batchwise, semi-batchwise or continuously. Stripping and distillation procedures can be included as a step of the process in order to purify the product of the reaction.

### EXAMPLES

The following examples are set forth in order to illustrate the invention in more detail.

### Example 1

This example shows the specificity of RhCl(di-tert-butylsulfide)₂ to catalyze the reaction of trimethoxysilane and vinylcyclohexene monoxide (VCMX) to form the end product 2-(3,4-epoxycyclohexyl)ethyltrimethoxysilane (ECHETMS). The reactor used consisted of a 500 milliliter flask equipped with a water cooled condenser, a magnetic stirrer, and a thermometer. The reactor was charged with 55.53 gram of vinylcyclohexene monoxide, 0.38 gram of a toluene solution containing 0.0057 gram of the RhCl(di-tert-butylsulfide)₂ catalyst. The mixture was stirred and heated to 70° C. After the mixture had reached 70° C., heat was removed, and 50.00 gram of trimethoxysilane were added, so as to provide a 10 percent molar excess of VCMX over the stoichiometric amount. The trimethoxysilane feed rate was regulated to ensure the temperature within the reactor remained between 70-80° C. After all of the trimethoxysilane had been added, the reactor temperature was maintained between 70-80° C. for 30 minutes. The reactor was then allowed to cool, and a sample was analyzed using gas chromatography. The analysis indicated a yield of 2-(3,4-epoxycyclohexyl)ethyltrimethoxysilane in terms of area percent of 84.07.

### Example 2

The effect of the reactor temperature, as well as the concentration of the rhodium catalyst RhCl(di-tert-butylsulfide)₂ and vinylcyclohexene monoxide, were evaluated in a series of eleven runs. All of the runs in the series were performed according to the following general procedure. To the reactor described in Example 1, were added vinylcyclohexene monoxide and RhCl(di-tert-butylsulfide)₂ in amounts such as to provide reactor concentrations as shown below in Table 1. The mixture was stirred and heated to temperature ranges of 70-75° C., 80-85° C., or 95-100° C. After the mixture had reached the desired temperature, heat was removed, and 50.00 gram of trimethoxysilane was added, to provide the molar excess of VCMX as shown in Table 1. The trimethoxysilane feed rate was regulated to ensure that the temperature within the reactor remained in the given range. After all of the trimethoxysilane had been added, the reactor temperature shown in Table 1 was maintained for 30 minutes. The reactor was then allowed to cool, and a sample was analyzed using gas chromatography.

TABLE 1
Effect of Reactor Temperature and Concentrations of VCMX and
RhCl(di-tert-butylsulfide)₂ on the Reaction of Trimethoxysilane
with VCMX

| | % Molar | ppm | | | % |
|---|---|---|---|---|---|
| Run | Excess of | of Rh | Reactor | Area % of | Trimethoxysilane |
| No. | VCMX | Catalyst | Temp ° C. | ECHETMS | Reacted |
| 1 | 20.09 | 9.72 | 95-100 | 75.74 | 83.41 |
| 2 | 20.11 | 31.19 | 95-100 | 67.29 | 74.11 |
| 3 | 39.90 | 29.28 | 80-85 | 69.00 | 82.88 |
| 4 | 39.86 | 10.30 | 80-85 | 69.23 | 83.14 |
| 5 | 39.98 | 9.84 | 95-100 | 67.53 | 81.14 |
| 6 | 20.11 | 10.99 | 80-85 | 79.07 | 87.08 |
| 7 | 39.94 | 30.67 | 95-100 | 66.15 | 79.47 |
| 8 | 20.00 | 30.16 | 80-85 | 76.56 | 84.28 |
| 9 | 30.03 | 14.67 | 70-75 | 74.80 | 86.12 |
| 10 | 19.99 | 9.98 | 70-75 | 78.29 | 86.18 |
| 11 | 10.04 | 10.19 | 70-75 | 84.07 | 88.32 |

In Table 1, Runs 1-8 were design of experiment (DOE) runs, and Runs 9-11 were optimizing runs based on the results of DOE Runs 1-8. Example 2 and Table 1 indicate that the optimal formulation for this particular reaction includes the use of a 10 percent molar excess of VCMX, 10 ppm of the Rh catalyst, and that the reactor temperature should be maintained at between 70-75° C. These conditions yielded the most product and provided the highest conversion of trimethoxysilane into the product, while minimizing byproducts. The effect of the temperature on the reaction was unexpected. For example, in DOE Runs 1-8, the temperature was higher than the temperature in the optimizing Runs 9-11. The DOE Runs 108 indicated that higher temperatures statistically produced lower product yields.

In addition, Table 1 shows that the RhCl(di-tert-butylsulfide)₂ rhodium catalyst is capable of catalyzing the hydrosilation reactions according to the invention, without opening of the epoxy ring; and that it can be used to catalyze such reactions, without the aid or addition of stabilizers such as the tertiary amines and carboxylic acid salts required in accordance with the teaching of the prior art, in order to obtain significant yields of the desired epoxyorganoalkoxysilane product.

The epoxyorganoalkoxysilane compositions prepared herein are useful as adhesion promoters for epoxy, urethane, and acrylic surfaces; as reinforcing materials for resins; in the surface pretreatment of fillers and reinforcing agents; and to enhance polyester tire cord adhesion.

Other variations may be made in compounds, compositions, and methods described herein without departing from the essential features of the invention. The embodiments of the invention specifically illustrated herein are exemplary only and not intended as limitations on their scope except as defined in the appended claims.

1. A method of making epoxyorganoalkoxysilanes comprising reacting an olefin epoxide with an hydridoalkoxysilane in the presence of RhCl(di-tert-butylsulfide)₂ catalyst, the reaction being free of the presence of a stabilizing agent, the reaction being carried out at a temperature in the range of 70-75° C., and the olefin epoxide being present in the reaction in a molar excess of 5-25 percent over the stoichiometric amount necessary to react with the hydridoalkoxysilane.

2. The method according to claim 1 in which the olefin epoxide is a composition selected from the group consisting of limonene oxide, 4-vinylcyclohexene monoxide, allyl glycidyl ether, glycidyl acrylate, vinyl norborene monoxide, dicyclopentadiene monoxide, and 1-methyl-4-isopropenyl cyclohexene monoxide.

3. The method according to claim 1 in which the hydridoalkoxysilane is a composition selected from the group consisting of trimethoxysilane HSi(OCH₃)₃, triethoxysilane HSi(OC₂H₅)₃, tri-n-propoxysilane HSi(OC₃H₇)₃, tri-isopropoxysilane HSi[(OCH(CH₃)₂]₃, methyldimethoxysilane (CH₃)HSi(OCH₃)₂, methyldiethoxysilane (CH₃)HSi(OC₂H₅)₂, dimethylmethoxysilane (CH₃)₂HSi(OCH₃), dimethylethoxysilane (CH₃)₂HSi(OC₂H₅), and phenyldiethoxysilane (C₆H₅)HSi(OC₂H₅) ₂.

4. The method according to claim 1 in which the olefin epoxide is 4-vinylcyclohexene monoxide and the hydridoalkoxysilane is trimethoxysilane HSi(OCH₃)₃.

5. A method of making epoxyorganoalkoxysilanes comprising reacting an olefin epoxide with an hydridoalkoxysilane in the presence of RhCl(di-tert-butylsulfide)₂ catalyst, the reaction being free of the presence of a stabilizing agent, the reaction being carried out at a temperature in the range of 65-95° C., and the olefin epoxide being present in the reaction in a molar excess of 5-25 percent over the stoichiometric amount necessary to react with the hydridoalkoxysilane; the olefin epoxide being selected from the group consisting of limonene oxide, 4-vinylcyclohexene monoxide, allyl glycidyl ether, glycidyl acrylate, vinyl norborene monoxide, dicyclopentadiene monoxide, and 1-methyl-4-isopropenyl cyclohexene monoxide.

6. (canceled)

7. (canceled)

8. (canceled)
